(19) United States
(12) Patent Application Publication
(10) Pub. No.: US 2003/0074795 A1
(43) Pub. Date: Apr. 24, 2003

(54) Hot Knife

(76) Inventors: Tammy Lorraines Marshall, Burbank, CA (US); Amanollah Ghahraman, Granada Hills, CA (US); I-To Tai, Hacienda Hts., CA (US)

Correspondence Address: JOE NIEH, 17800 CASTLETON STREET, SUITE 475, CITY OF INDUSTRY, CA, 91748, US

(21) Appl. No.: 09/982,471

(22) Filed: Oct. 18, 2001

(51) Int. Cl. B25F 3/00

(52) U.S. Cl. 30/140; 30/123

(57) ABSTRACT

The present invention is a heated cutting tool for cutting materials with a relatively low melting temperature such as waxes, bars of soap, and foam materials. The present invention comprises of a thin metallic blade that is rigidly attached to a handle. The thin metallic blade contains a heating element within it. A mean of applying and controlling the electric current to the heating element is contained within the handle. The electricity may be supplied by conventional 110V alternating current source or from a suitable direct current source. When electricity is applied to the heating element within the thin metallic blade, the entire blade will heat up to a temperature sufficient to melt the material being cut, such as wax, a bar of soap, or foam material.

### BACKGROUND

1. Field of Invention

The present invention relates to a heated cutting tool for cutting materials with a relatively low melting temperature such as waxes, bars of soap, and foam materials.

2. Background-Description of Related Art

Waxes, bars of soap, and foam materials are relatively soft materials with a relatively low melting temperature. Generally, one would cut waxes, bars of soap, or foam materials with a sharp tool such as a knife. The process involves determining where the cut would be located, selecting a sharp cutting tool, and cutting the wax, the bar of soap, or the foam material with the cutting tool by applying sufficient pressure to the cutting tool to complete the cut through the wax, the bar of soap, or the foam material.

The process is relatively simple and generally can be carried out with ease for a cut with a relatively small cross-section. However, with a larger cross-section cut, the process becomes very difficult. The larger cross-section cut would require application of much greater amount of force and the risk of breaking and destroying the wax, the bar of soap, or the foam material being cut increase dramatically. On a large cross-section cut, the conventional cutting procedure is virtually impossible to complete without breaking the material being cut. Furthermore, the conventional cutting procedure will produce fractures and shavings of the materials being cut. The conventional cutting procedure requires application of brute force and patience to complete, particularly on a large cross-section cut.

### SUMMARY OF THE INVENTION

The present invention is a heated cutting tool for cutting and melting materials with a relatively low melting temperature such as waxes, bars of soap, and foam materials. The present invention comprises of a thin metallic blade containing a heating element within it. The thin metallic blade with the heating element is rigidly attached to a handle. A mean of applying and controlling the electric current to the heating element is contained within the handle. The electricity may be supplied by conventional 110V alternating current or from a suitable direct current source. When electricity is applied to the heating element within the thin metallic blade, the entire blade will heat up to a temperature sufficient to melt the material being cut, such as wax, a bar of soap, or foam material.

### BRIEF DESCRIPTION OF THE DRAWINGS

FIG. 1 shows the front view of the present invention.

FIG. 2 shows side view of the present invention.

FIG. 3 shows top view of the present invention.

FIG. 4 shows the circuit within the hollow interior of the handle of the present invention.

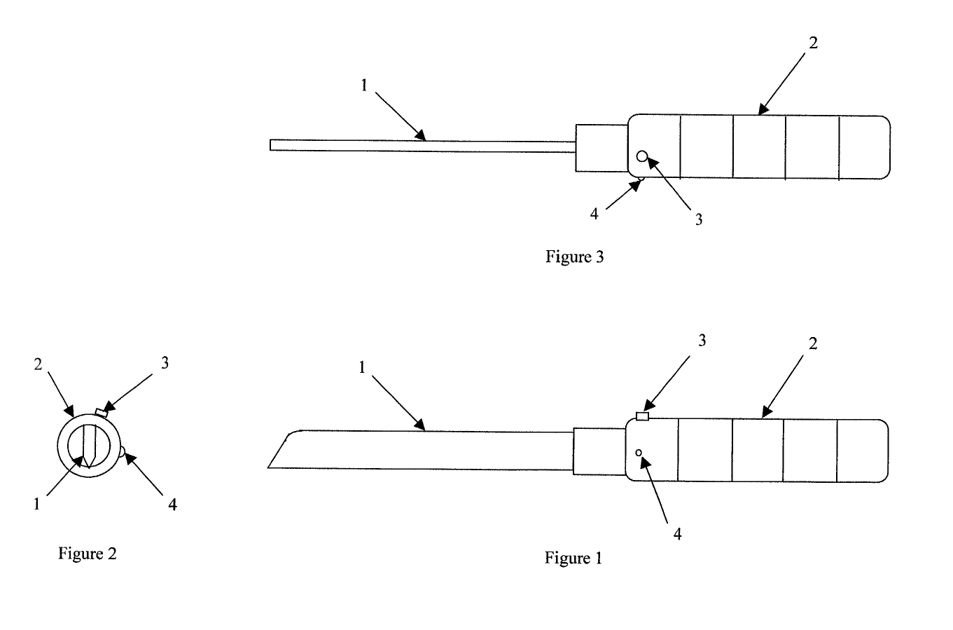

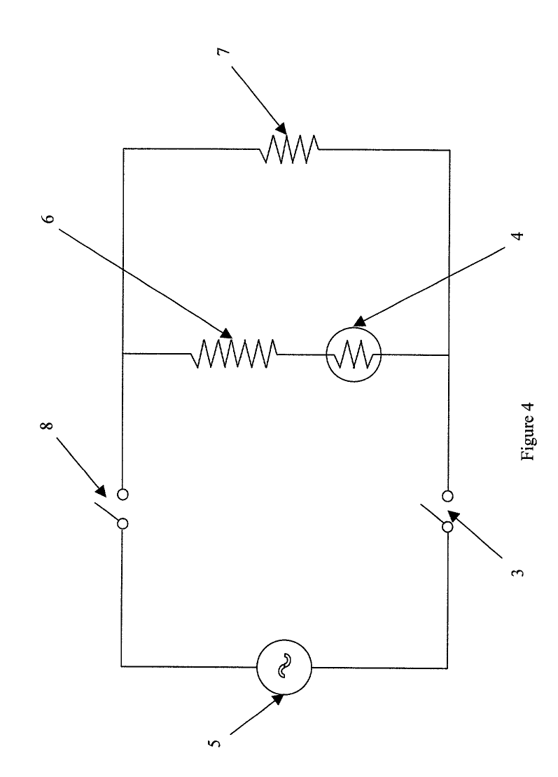

### DETAILED DESCRIPTION OF THE PREFERRED EMBODIMENT

The preferred embodiment of the present invention comprises of a thin metallic blade 1 with a thickness of approximately ¼ inch, a width of approximately ¾ inch, and a length of approximately 6 inches. The thin metallic blade 1 has a thin hallow chamber within which is fitted with a thin heating element 7 insulated on both sides by a layer of thin mica sheets. The thin metallic blade 1 containing the thin heating element 7 is rigidly attached to a handle 2 with a hollow interior. The hollow interior of the handle 2 contains the circuit shown in FIG. 4 for regulating the flow of electricity 5 and the temperature of the thin heating element 7 in the thin metallic blade 1.

In the preferred embodiment of the present invention, the circuit shown in FIG. 4 in the hollow interior of the handle 2 comprises of a power on/off switch 3, a light emitting diode (LED) 4 connected in series to a resister 6, a thin heating element 7 connected in parallel to the LED 4 and the resister 6, and then connected in series with a thermostat 8. In the preferred embodiment, a resister 6 of 65 kilo-Ohms is connected in series with the LED 4 and a thin heating element 7 with a resistance of 55 Ohms is connected in parallel to both the LED 4 and the resister 6. When electricity 5 is applied to the circuit shown in FIG. 4 by activating the power on/off switch 3, the LED 4 will light up, indicating that the present invention is activated, and the thin heating element 7 in the thin metallic blade 1 will begin to heat up rapidly. When a predetermined temperature is reached the thermostat 8 will cut off the electricity 5 to the thin heating element 7 thereby preventing damage to the thin heating element 7 and the present invention. In the preferred embodiment, the temperature is set at approximately 120 degrees Celsius. When the temperature of the thin heating element 7 drops to a predetermined temperature, the thermostat 8 will enable the flow of electricity 5 to the thin heating element 7, thereby raising its temperature. The predetermined temperature is controlled by the placement of the thermostat 8 relative to the thin heating element 7. In the preferred embodiment, the thermostat 8 is located approximately ¼ inch from the thin heating element 7 and on the thin metallic blade 1. When the power on/off switch 3 is released, the circuit shown in FIG. 4 will be open and the present invention is turned off.

Thus the power on/off switch 3 can be activated manually for the thin metallic blade 1 to reach the desired melting temperature of the material that is being cut. The present invention can then be used to easily cut and melt materials such as waxes, bars of soap, or foam materials without applying much force. Furthermore, the resulting cut will be smooth, clean, and free of any fractures or shavings.

What is claimed is:

1. A hot knife comprising:
a thin metallic blade with a hollow chamber defined by an outer wall and an inner wall enclosing a heat source that will supply heat to the thin metallic blade;
a handle rigidly attached to the thin metallic blade and enclosing means for regulating the temperature of the thin metallic blade;
wherein the hot knife can be used to easily cut materials with a relatively low melting temperature after the heat source raises the temperature of the thin metallic blade to a desired temperature.

2. A hot knife as in claim 1, wherein the heat source in the thin metallic blade is a flexible heating element electrically insulated from the inner walls of the thin metallic blade.

3. A hot knife as in claim 2, wherein the means for regulating the temperature of the thin metallic blade comprises of an electrical circuit with a thermostat and a power on/off switch which controls the flow of electricity to the heating element thereby controlling the temperature of and protecting the heating element.

4. A hot knife as in claim 3, wherein the thermostat is located within ½ inch from the heating element and on the thin metallic blade.

5. A hot knife as in claim 3, wherein the thermostat is located ¼ inch from the heating element and on the thin metallic blade.
